(19) United States
(12) Patent Application Publication
(10) Pub. No.: US 2010/0312810 A1
(43) Pub. Date: Dec. 9, 2010

(54) SECURE IDENTIFICATION OF MUSIC FILES

(76) Inventors: Christopher Horton, Culver City, CA (US); Dmitry Radbel, Pacific Palisades, CA (US); Simon Watt, Burwell Cambs (GB)

Correspondence Address: IP Patent Docketing;K&L GATES LLP, 599 Lexington Avenue, 33rd Floor, New York, NY, 10022-6030, US

(21) Appl. No.: 12/481,355

(22) Filed: Jun. 9, 2009

(51) Int. Cl. G06F 17/30

(52) U.S. Cl. 707/912; 707/957

(57) ABSTRACT

Digital content files may include media content, metadata uniquely identifying a transaction in which the content file was obtained, and a digital signature of at least a portion of the metadata. The metadata may include a distributor ID, a date and time of the transaction, an asset ID, a secure hash of the media content, a nonce, and one of a user ID, uniquely identifying a user who obtained the content file in the transaction, and a transaction ID uniquely identifying the transaction.

### BACKGROUND

Digital files often contain proprietary content, for example audio recordings of music or other content. Owners of the proprietary content stored in digital files have an interest in distinguishing between legitimately and illegitimately acquired copies of digital files containing their content. In addition, content owners may also have an interest in distinguishing between different instances of legitimate copies.

For example, content owners may have an interest in tracking instances of digital files containing their content. To do so a content owner may wish to differentiate between different legitimately acquired copies of digital files containing their content. As another example, a content owner may wish to identify the retailer (or distributor) that sold a certain instance of a digital file. Similarly, a content owner may wish to identify the date and time that a certain instance of a digital file was sold or distributed.

### SUMMARY

Example embodiments of the present invention may provide a procedure for creating a traceable content file for distribution, which may include transacting, with a content distribution server, to supply a content file to a user; creating, with the content distribution server, metadata uniquely identifying the transaction for the content file; creating, with the content distribution server, a digital signature of at least a portion of the metadata; embedding, with the content distribution server, the metadata and the digital signature in the content file; transmitting, with the content distribution server, the content file, the metadata, and the digital signature, to the user; and making a public key associated with the digital signature available to a content owner of the content file, with the content distribution server, the public key configured to allow the content owner to validate the digital signature and the metadata.

Some example procedures may further include embedding, with the content distribution server, the metadata and the digital signature in the content file.

Some example procedures may further include transmitting a record of the transaction to the content owner.

In some example procedures the metadata may includes a distributor identifier; a date and time of the transaction; an asset identifier; a secure hash generated from a non-metadata portion of the content file; a nonce, randomly generated at the time of the transaction; and one of a user identifier, uniquely identifying the user, and a transaction identifier, uniquely identifying the transaction.

In some example procedures the secure hash may be received from the content owner.

In some example procedures the user identifier may be one of an email address, the user's name, an account identifier, login information, and a telephone number.

In some example procedures the metadata may further contain a URL.

In some example procedures the metadata may further contain a parental advisory indicator.

In some example procedures the metadata may further contain copyright information.

In some example procedures the content file may be an MP3 file; and the metadata and the digital signature may be embedded in a PRIV ID3 tag.

In some example procedures the metadata and the digital signature may be embedded in XML form.

Other example embodiments may provide a content file distribution system, which may include a transaction component configured to transact to supply a content file to a user; a metadata creation component configured to create metadata uniquely identifying the transaction for the content file; a digital signature component configured to create a digital signature of at least a portion of the metadata; and a distribution component configured to transmit the content file, the metadata, and the digital signature, to the user; wherein the content file distribution system may be configured to make a public key associated with the digital signature available to a content owner of the content file, the public key configured to allow the content owner to validate the digital signature and the metadata.

Some example systems may further include a file creation component configured to embed the metadata and the digital signature in the content file.

In some example systems the system may be further configured to transmit a record of the transaction to the content owner.

In some example systems the metadata may further include a distributor identifier; a date and time of the transaction; an asset identifier; a secure hash generated from a non-metadata portion of the content file; a nonce, randomly generated at the time of the transaction; and one of a user identifier, uniquely identifying the user, and a transaction identifier, uniquely identifying the transaction.

In some example systems the secure hash may be received from the content owner.

In some example systems the user identifier may be one of an email address, the user's name, an account identifier, login information, and a telephone number.

In some example systems the metadata may further contain a URL.

In some example systems the metadata may further contain a parental advisory indicator.

In some example systems the metadata may further contain copyright information.

In some example systems the content file may be an MP3 file; and the metadata and the digital signature may be embedded in a PRIV ID3 tag.

In some example systems the metadata and the digital signature may be embedded in XML form.

Other example embodiments may provide for a procedure for auditing a distributor of digital content, which may include receiving, with a digital content audit server, a content file obtained from a content distributor through a transaction, the content file containing metadata uniquely identifying the transaction and a digital signature of at least a portion of the metadata; receiving, with the digital content audit server, from the content distributor a list of transactions for content files entered into by the content distributor; searching, with the digital content audit server, the list of transactions for the transaction identified by the metadata; and responsive to an indication that the transaction was not found, recording, with the digital content audit server, an indication that the transaction was not reported.

Some example procedures may further include receiving, with the digital content audit server, a second content file obtained from the content distributor through a second transaction, the second content file containing second metadata uniquely identifying the second transaction and a second digital signature of at least a portion of the second metadata; comparing, with the digital content audit server, the metadata to the second metadata; and responsive to a determination that a portion of the metadata uniquely identifying the transaction is identical to a portion of the second metadata uniquely identifying the second transaction, recording, with the digital content audit server, an indication that the content distributor is not property identifying transactions.

In some example procedures the metadata may further include a distributor identifier; a date and time of the transaction; an asset identifier; a secure hash generated from a non-metadata portion of the content file; a nonce, randomly generated at the time of the transaction; and one of a user identifier, uniquely identifying the user, and a transaction identifier, uniquely identifying the transaction.

In some example procedures the content file may be an MP3 file; and the metadata and the digital signature may be embedded in a PRIV ID3 tag.

In some example procedures the metadata and the digital signature may be in XML form.

Other example embodiments may provide a digital content audit server, which may include a file load component configured to receive a content file obtained from a content distributor through a transaction, the content file containing metadata uniquely identifying the transaction and a digital signature of at least a portion of the metadata; a transaction report component configured to receive from the content distributor a list of transactions for content files entered into by the content distributor; and a analysis component configured to search the list of transactions for the transaction identified by the metadata, and, responsive to an indication that the transaction was not found, record an indication that the audit failed.

In some example systems the file load component may be further configured to receive a second content file obtained from the content distributor through a second transaction, the second content file containing second metadata uniquely identifying the second transaction and a second digital signature of at least a portion of the second metadata; and the analysis component may be further configured to compare the metadata to the second metadata, and, responsive to a determination that a portion of the metadata uniquely identifying the transaction is identical to a portion of the second metadata uniquely identifying the second transaction, record an indication that the content distributor is not property identifying transactions.

In some example systems the metadata may include a distributor identifier; a date and time of the transaction; an asset identifier; a secure hash generated from a non-metadata portion of the content file; a nonce, randomly generated at the time of the transaction; and one of a user identifier, uniquely identifying the user, and a transaction identifier, uniquely identifying the transaction.

In some example systems the content file may be an MP3 file; and the metadata and the digital signature may be embedded in a PRIV ID3 tag.

In some example systems the metadata and the digital signature may be in XML form.

Other example embodiments may provide a procedure for providing access to bonus content, which may include receiving, with an access control server, metadata and a digital signature which are associated with a content file obtained from a content distributor through a transaction, wherein the metadata uniquely identifies the transaction, and wherein the digital signature is made from at least a portion of the metadata; validating, with the access control server, the metadata and the digital signature; determining, with the access control server, whether access to bonus content has been requested more than a predetermined number of times using the content file, where the content file is identified using the metadata; and responsive to an indication that the digital signature and the metadata are valid and an indication that access to the bonus content has been requested less than the predetermined number of times using the content file, allowing access to the bonus content, with the access control server.

In some example procedures the metadata may include a distributor identifier; a date and time of the transaction; a track identifier; a secure hash generated from a non-metadata portion of the content file; a nonce, randomly generated at the time of the transaction; and one of a user identifier, uniquely identifying the user, and a transaction identifier, uniquely identifying the transaction.

In some example procedures the content file may be an MP3 file; and the metadata and the digital signature may be embedded in a PRIV ID3 tag.

In some example procedures the metadata and the digital signature may be in XML form.

In some example procedures the predetermined number may be 1.

In some example procedures determining whether access to the bonus content has been requested more than a predetermined number of times using the content file, may include searching for the metadata in a list of metadata used to request access to the bonus content.

In some example procedures the metadata and the digital signature may be embedded in the content file.

In some example procedures allowing access to the bonus content may further include issuing an access token configured to allow access to the bonus content.

Other example embodiments may provide for a system for providing access to bonus content, which may include a request component configured to receive metadata and a digital signature which are associated with a content file obtained from a content distributor through a transaction, wherein the metadata uniquely identifies the transaction, and wherein the digital signature is made from at least a portion of the metadata; a validation component configured to validate the metadata and the digital signature, and configured to determine whether access to bonus content has been requested more than a predetermined number of times using the content file, where the content file is identified using the metadata; and an access component configured to, responsive to an indication that digital signature and the metadata are valid and an indication that access to the bonus content has been requested less than the predetermined number of times using the content file, allow access to the bonus content.

In some example systems the metadata may include a distributor identifier; a date and time of the transaction; an asset identifier; a secure hash generated from a non-metadata portion of the content file; a nonce, randomly generated at the time of the transaction; and one of a user identifier, uniquely identifying the user, and a transaction identifier, uniquely identifying the transaction.

In some example systems the content file may be an MP3 file; and the metadata and the digital signature may be embedded in a PRIV ID3 tag.

In some example systems the metadata and the digital signature may be in XML form.

In some example systems the predetermined number may be 1.

In some example systems the validation component may be further configured to determine whether access to the bonus content has been requested more than a predetermined number of times using the content file by searching for the metadata in a list of metadata used to request access to the bonus content.

In some example systems the metadata and the digital signature may be embedded in the content file.

In some example systems the access component may be further configured allow access to the bonus content by issuing an access token configured to allow access to the bonus content.

Other example embodiments may provide a procedure for rendering media content based on authenticated metadata, which may include receiving, with a rendering device, a content file containing metadata and a digital signature of at least a portion of the metadata, wherein the metadata includes a secure hash of media content stored in the content file; identifying, with the rendering device, information in the metadata usable to control rendering of the media content; determining, with the rendering device, whether the metadata is the same as original metadata used to create the digital signature; determining, with the rendering device, whether the media content is the same as original media content used to create the secure hash; and responsive to an indication that the metadata is the same as the original metadata and the media content is the same as the original media content, rendering, with the rendering device, the media content according to the information.

In some example procedures the metadata may include a distributor identifier; a date and time of the transaction; an asset identifier; a nonce, randomly generated at the time of the transaction; and one of a user identifier, uniquely identifying the user, and a transaction identifier, uniquely identifying the transaction.

In some example procedures the content file may be an MP3 file; and the metadata and the digital signature may be embedded in a PRIV ID3 tag.

In some example procedures the metadata and the digital signature may be in XML form.

Other example embodiments may provide a media rendering system which may include a file load component configured to receive a content file containing metadata and a digital signature of at least a portion of the metadata, wherein the metadata includes a secure hash of media content stored in the content file; a metadata extraction component configured to identify information in the metadata usable to control rendering of the media content; an authentication component configured to determine whether the metadata is the same as original metadata used to create the digital signature, and configured to determine whether the media content is the same as original media content used to create the secure hash; and a rendering component configured to, responsive to an indication that the metadata is the same as the original metadata and the media content is the same as the original media content, render with the rendering device, the media content according to the information.

In some example systems the metadata may include a distributor identifier; a date and time of the transaction; an asset identifier; a nonce, randomly generated at the time of the transaction; and one of a user identifier, uniquely identifying the user, and a transaction identifier, uniquely identifying the transaction.

In some example systems the content file may be an MP3 file; and the metadata and the digital signature may be embedded in a PRIV ID3 tag.

In some example systems the metadata and the digital signature may be in XML form.

Other example embodiments may provide a tangible computer readable medium storing a content file which may include media content; metadata uniquely identifying a transaction in which the content file was obtained; and a digital signature of at least a portion of the metadata; wherein the metadata may include a distributor identifier, a date and time of the transaction, an asset identifier, a secure hash of the media content, a nonce, and one of a user identifier, uniquely identifying a user who obtained the content file in the transaction, and a transaction identifier uniquely identifying the transaction.

In some tangible computer readable media the metadata and digital signature may be structured using XML; and the XML used to contain the digital signature may identify the hash and signature algorithms used to generate the digital signature.

### BRIEF DESCRIPTION OF THE DRAWINGS

FIG. 1 illustrates a metadata payload in accordance with an example embodiment of the present invention.

FIG. 2 illustrates a signature block in accordance with an example embodiment of the present invention.

FIG. 3 illustrates a procedure in accordance with an example embodiment of the present invention.

FIG. 4 illustrates a system in accordance with an example embodiment of the present invention.

FIG. 5 illustrates a procedure in accordance with an example embodiment of the present invention.

FIG. 6 illustrates a system in accordance with an example embodiment of the present invention.

FIG. 7 illustrates a procedure in accordance with an example embodiment of the present invention.

FIG. 8 illustrates a system in accordance with an example embodiment of the present invention.

FIG. 9 illustrates a procedure in accordance with an example embodiment of the present invention.

FIG. 10 illustrates a system in accordance with an example embodiment of the present invention.

### DETAILED DESCRIPTION OF EXAMPLE EMBODIMENTS

Some example embodiments of the present invention address the tracking and authentication of particular instances of digital files. For example, some example embodiments provide for the creation and distribution of digital files containing both content and features designed to authenticate that content. For instance, some example embodiments of the present invention describe procedures for creating cryptographically signed metadata that can be transmitted separately or embedded into files. This metadata can be used for various purposes, such as providing an access token for bonus content, as a tool for sales auditing, and for detecting when important metadata has been modified. Accordingly, other example embodiments may use such metadata and digital files to audit content distributors, provide bonus content to the purchasers of authentic content, and securely transmit metadata in a tamper resistant form.

It is noted that throughout the following description, example embodiments may be described as applying to audio recordings and may also discuss particular formats in which such content may be encoded. It is to be understood, however, that such examples are not intended to be limiting and other example embodiments may apply to any type of content. For example, embodiments may also apply to video content, to image content, to combinations of video and audio content, and to non-media content, such as the distribution of computer programs or data sets.

### Digital Content Files

As noted, some example embodiments of the present invention provide for the creation of digital files containing information which may facilitate the tracking and authentication of such files. Some embodiments of the present invention may provide for digital content files containing information by which they may be uniquely identified. For example, in one embodiment, a metadata payload may be inserted into or associated with a certain instance of a digital file. In a specific embodiment where the digital file is a digital music file in mp3 (MPEG-1 Audio Layer 3) format, the metadata payload may be embedded within a PRIV ID3 tag or an ID3 comments field within the mp3 file. When examined, the metadata payload for a given instance of a digital file may allow authentication of the digital file, and may allow certain tracking operations to be performed. In certain embodiments, metadata payload may be implemented using Extensible Markup Language (“XML”). Of course, there is no requirement that the content be encoded in mp3 form. Rather, the present invention applies to content encoded in any file format, and the metadata described herein may be inserted into such files in any acceptable location.

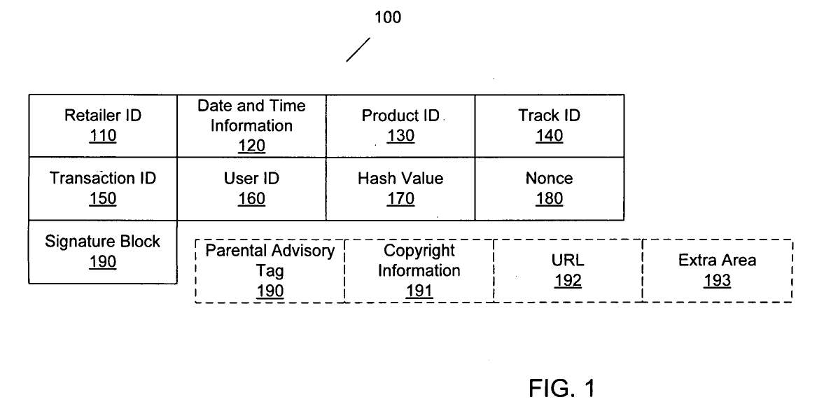

As shown in the block diagram in FIG. 1, the metadata payload 100 associated with a certain instance of a digital file may contain various pieces of information. Specifically, metadata payload 100 may contain: retailer ID 110, date and time information 120, product ID 130, track ID 140, transaction ID 150, user ID 160, hash value 170, nonce 180, and signature block 190. It is recognized that metadata payload 100 may contain all of the elements listed above, or, alternatively, a subset or superset thereof. It is recognized that FIG. 1 is a block diagram, and that the data in metadata payload 100 may be organized in any number of ways.

In some embodiments, retailer ID 110 may be used to identify a certain retailer or distributor of instances of digital files. In such an embodiment, the retailer or distributor may keep records of the sale or distribution of each instance of a digital file. In some embodiments, the retailer or distributor may generate reports of such sales and distribution to the owner of the content in the instances of the digital files. In one embodiment, retailer ID 110 may appear in metadata payload 100 as the retailer's name in clear text. In other embodiments, retailer ID 110 may be some other identifier of a certain retailer, or it may be encrypted or obfuscated in some fashion.

In some embodiments, date and time information 120 may be used to identify the date and/or time that the specific instance of the digital file was created, purchased, or distributed. In some embodiments, date and time information 120 may be in the ISO 8601 format, as specified by the International Organization for Standardization. In such embodiments, date and time information 120 may be in Coordinated Universal Time (“UTC”) or in local time plus offset form.

In certain embodiments, product ID 130 may be used to indicate the specific product purchased that triggered the distribution of the digital file. For example, if a consumer purchased a music album consisting of multiple digital music files, the metadata payload 100 for each of the digital music files could contain a product ID 130 identifying the album purchased. In some embodiments, product ID 130 may be a Universal Product Code (“UPC”). In embodiments where the digital file is a music file, product ID 130 may be a Global Release Identifier (“GRID”).

Track ID 140 may, in some embodiments, be used to describe the contents of the digital file. In an embodiment where the digital file is a digital music file, Track ID 140 may be the International Standard Recording Code (“ISRC”) associated with the song contained in the digital music file.

In some embodiments, transaction ID 150 may be a retailer-specific, unique identifier for a given transaction. In an example embodiment, transaction ID 150 may be generated using a cryptographic hash algorithm such as SHA-1 or SHA-256, e.g., by applying such algorithms to a retailer-specific, transaction identifier. In another embodiment, transaction ID 150 may be a random identifier from a very large identifier space (e.g., 16 alphanumeric characters or 20 hex digits). In some embodiments, a list of all transaction IDs 150 that are generated may be maintained so as to avoid having two transactions associated with the same transaction ID 150. In some such embodiments, the list of transaction IDs 150 may be reported to the owner of the content within the digital files. Transaction ID 150 may be used to refer to an entire transaction, such that if a user purchases several instances of several digital files at one time, the same transaction ID 150 may be associated with each instance of each digital file. However, if the same user purchases two different instances of the same digital file at different times, then different transaction ID 150s may be used.

In some embodiments, user ID 160 may be a unique identifier for a given user. In some embodiments, user ID 160 may be a handle or login ID chosen by the user, a user's email address, or a user's service ID number. In other embodiments, user ID 160 may be generated using a cryptographic hash algorithm such as, e.g. an HMAC (keyed-Hash Message Authentication Code) algorithm applied to the user's email or ID number so that it cannot be traced back to the user. In another embodiment, user ID 160 may be a random identifier from a very large identifier space (e.g., 16 alphanumeric characters or 20 hex digits). In all cases, the user ID 160 may be generated so as to avoid having two users associated with the same user ID 160. In some embodiments, user ID 160 may be static—i.e., if a given user purchases or receives multiple instances of multiple digital files, the same user ID 160 will be associated with each instance of each digital file. In the event one user buys a digital file as a gift for another user, the recipient's user ID may be stored as user ID 160.

Media ID 170 may, in some embodiments, be a hash of a portion of the digital file. Media ID 170 can be generated using the SHA-256 algorithm, though any number of hash algorithms could be used. In other embodiments, the media ID may be a fingerprint, or may be a value from an embedded watermark. Media ID 170 may be computed at the time of sale or distribution, or it may be computed prior to such times. In certain embodiments, Media ID 170 may be created from a portion of the digital file that is not readily alterable. Media ID 170 may be used to tie metadata payload 100 to specific digital file. In an embodiment where the digital file is a digital music file, Media ID 170 may be created from the audio portion of the digital music file.

In a specific embodiment where the digital file is a digital music file in mp3 format, media ID 170 may be calculated using the SHA-256 hash algorithm over all of the audio frames within the mp3 file in the order in which they appear in the mp3 file. Frames that are not audio are excluded from the hash. Typically, the audio frames in an mp3 file all begin with and can be identified by a 12-bit syncword, and their frame size is calculated from the bitrate, sampling and padding. At present, at least one type of audio frame may be identified and excluded from the cryptographic hash-Xing variable byte rate data frames.

In certain embodiments, nonce 180 may be used for security purposes. In cryptography, a nonce (or “number used once”) may be a random or pseudo-random number used to prevent replay and dictionary attacks. Nonce 180 may be, in some embodiments, an 8-digit, Base64 encoded, random value generated at the time the instance of the digital file is sold, distributed, or created.

In addition, some embodiments may allow for the introduction of other optional metadata. For example, embodiments may provide for a parental advisory tag 190. The parental advisory tag may allow for the inclusion of information identifying parental advisory status of the content of a digital file, e.g., indicating that the content is “edited,” “explicit,” or “unspecified.” In other examples, copyright status 191 may be encoded in the metadata. For example, copyright status information might indicate that the copyright status of the content encoded is “unspecified,” “all rights reserved,” “pre-release,” “other,” etc., and also provide other relevant copyright information such as the name of a copyright holder, etc. In some cases, such as where “other” is used, a URL might be used to indicate a location where specific copyright terms may be found.

In other embodiments, a URL 192 may be identified in the metadata, for instance a URL linking to a webpage of the content owner, or artist, etc. Additionally, any type of metadata may be included, and metadata is not limited to the types discussed herein.

In some embodiments, an extra area 193 may be included, for carrying other metadata that the content owner wishes to be cryptographically signed. For example, the content owner might include a name value pair of arbitrary metadata.

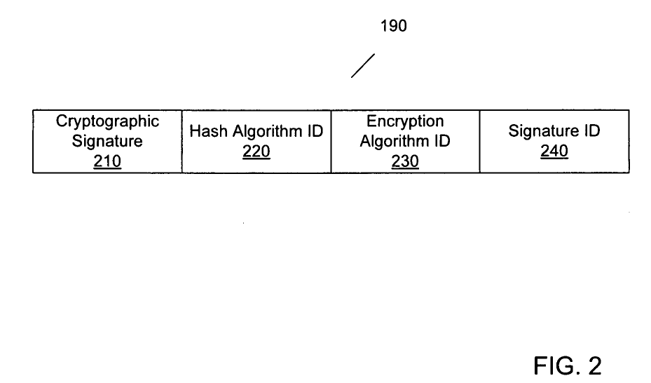

Signature block 190 can be used to verify the integrity of the data within metadata payload 100. Signature block 190 is depicted in more detail in FIG. 2. As shown in FIG. 2, signature block 190 may comprise: cryptographic signature 210, hash algorithm ID 220, signature algorithm ID 230, and signature ID 240. It is recognized that signature block 190 may contain all of the elements listed above, or, alternatively, a subset or superset thereof. In addition, the signature block 190 may include a combination hash/signature ID that identifies both the signature and hash used with a single identifier.

In some embodiments, the contents of metadata payload (other than signature block 190) may be cryptographically signed, and the result may be stored as cryptographic signature 210. In an embodiment where metadata payload 100 is implemented using XML, the contents of metadata payload (other than signature block 190) may be enclosed within <metadata> XML tags (which may use, e.g., UTF-8, UTF-16 or another encoding), and the contents of the tags (inclusive of the tags themselves) may be cryptographically signed. The resulting signature may then be stored as cryptographic signature 210. In some embodiments, the cryptographic signature 210, the associated algorithm IDs 220 and 230, and the key ID 240 may be implemented using XML. In certain embodiments, the cryptographic signature may be performed using a private cryptographic key, where the private cryptographic key is associated with a public cryptographic key, and the key pair may be associated with signature ID 240. Cryptographic signature 210 may be created using the SHA-1 and/or RSA algorithms, and may specifically use the RSASSA-PKCSI-v1_5 algorithm. Alternatively, cryptographic signature 210 may be generated using the SHA-224 and DSA algorithms, or any other suitable hash and signature algorithms.

The digital signature may be performed by hashing the contents of metadata payload (other than signature block 190), and subsequently cryptographically signing the result of that hash. The hash may be performed using the SHA-256 algorithm, though other algorithms may be used. Hash algorithm ID 220 may be used to identify the specific algorithm used. Similarly, the signature may be performed using the RSA2048 algorithm, though other algorithms may be used. Signature algorithm ID 230 may be used to identify the specific algorithm used. In an embodiment where cryptographic signature 210 is generated using other or proprietary algorithms, hash algorithm ID and/or signature algorithm ID 230 may be used to identify that algorithm; or an ID may be used to identify a single hash/signature algorithm combination, e.g., a single ID specifying the DSA 2048 signature algorithm with the SHA-224 hash.

Cryptographic signature 210 may be used to verify the contents of metadata payload 100 (other than signature block 190). If a metadata payload is being reviewed, the cryptographic signature can be re-generated using the algorithms identified in hash algorithm ID 220 and signature algorithm ID 230. Then, if the generated cryptographic signature does not match the value in cryptographic signature 210, it will be known that the metadata payload has been altered. If the metadata payload associated with an instance of a digital file has been altered, that instance of a digital file may have been acquired illegitimately.

In an embodiment where metadata payload 100 is implemented using XML, the contents of signature block 190 may be enclosed within <signature> XML tags, which may, e.g., use UTF-8 or UTF-16 encoding. In such an embodiment, the individual elements within the metadata payload 100 may be enclosed within XML tags. Similarly, the entire metadata payload 100 may be enclosed within XML tags. In certain embodiments, the XML tags may use UTF-8 or UTF-16 encoding, etc.

It is recognized that the elements within metadata payload 100 and/or signature block 190 may be combined in various manners. In some embodiments, the various elements may be appended to one another. In other embodiments, the various elements may be mathematically combined.

As explained above, each metadata payload 100 may be embedded within or associated with an instance of a digital file. In some embodiments, metadata payload 100 may generated and embedded within an instance of a digital file by a retailer who sells (or a distributor who distributes) that instance of the digital file to a consumer. Alternatively, metadata payload 100 may be generated on a retailer's server but embedded by a download manager on a consumer's computer. In such an embodiment, the download manager may be configured to prevent and detect unauthorized access or interference with the embedding process.

Metadata payload 100 can be verified in numerous ways. For instance, if the signature cannot be validated, then the payload may be identified as invalid. Similarly, if the data in metadata payload 100 relating to the content of the digital file (e.g., product ID 130, track ID 140) does not match the actual content of the digital file, then the metadata payload 100 will be known to be invalid. As another example, if a metadata payload 100 contains a retailer ID 110 for a specific retailer and that retailer did not sell or distribute the digital file, the metadata payload 100 will be known to be invalid. Similarly, if a given metadata payload 100 contains date and time information 120 and the digital file was not available at that date and time, the metadata payload 100 will be known to be invalid. In another example, if the media ID 170 is a hash value and does not match the value generated by computing the hash on the content of the digital file, then the metadata payload will be known to be invalid. If the metadata payload associated with an instance of a digital file is invalid, it is likely that instance of a digital file was acquired illegitimately.

### Creation and Distribution of Digital Content Files

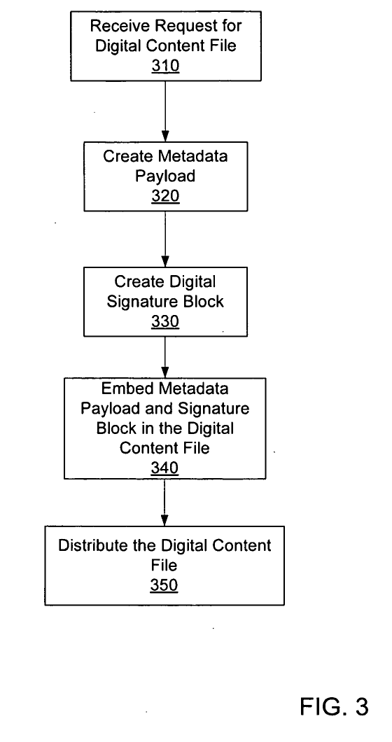

FIG. 3 is a flowchart illustrating an example method for distributing a digital file in accordance with embodiments of the present invention. As shown in box 310, a request for an instance of a digital file may be received. For instance, the request may be received by a distributor or retailer of digital content. Such a request may be received from a user and may be made using any reasonable communication method. For example the user may connect to a retailer website over the Internet, and may enter a request using the website.

On receiving a request, the retailer or distributor may enter into a transaction for an instance of a content file. For example the retailer may agree to sell the content file to the user for a fee, which may be collected from the user. In addition, the retailer may record information identifying the transaction. For example, the retailer may record the date/time of the transaction, account information if the user has an account with the retailer, other identifying information such as the user's name, IP address, etc.

A metadata payload may then be created 320. It is understood that the metadata payload may be in the format described above, though in certain embodiments it may be in some other format. The metadata may include any of the information discussed above as well as other information. For instance, the metadata may include information identifying the transaction, a secure hash of the content of the file, information identifying the user, etc. Also as explained above, in example embodiments the metadata may be formatted in XML form.

Once created the metadata may be digitally signed, as explained above 330. The digital signature may be created using any of the techniques discussed above, or other suitable techniques. For example, the signature may be created using a hash algorithm and an asymmetric signature algorithm, as explained above. In some examples, retailers may be required to create a public-private key pair, for example on a periodic basis, which may be used to create the digital signature. Once created the digital signature, as well as other information discussed above in connection with signature blocks, may be embedded in the content file. In some embodiments, the public key created may be communicated to a content owner, e.g., using an openSSL compatible x509 certificate in .pem format, or in any other suitable way.

The metadata payload and the digital signature block may then be embedded within the instance of the digital file 340. For example, as explained above, the metadata and signature may be embedded in a PRIV ID3 tag assuming the digital file is an mp3 file. Of course the metadata and signature may be embedded in other locations and in other forms to suit different types of files. In addition, in some embodiments the metadata and signature need not be embedded in the digital file at all. Rather the digital file, the metadata, and the signature block may be created and distributed separately, although they may be distributed at the same time or using the same medium.

Finally, in 350, the instance of the digital file may be distributed. For example, the retailer or distributor may make the file available for download, may email the file to the user, or may transmit the file in any other way. The retailer may keep a record of the transaction, which, as discussed herein, it may make available to a content owner.

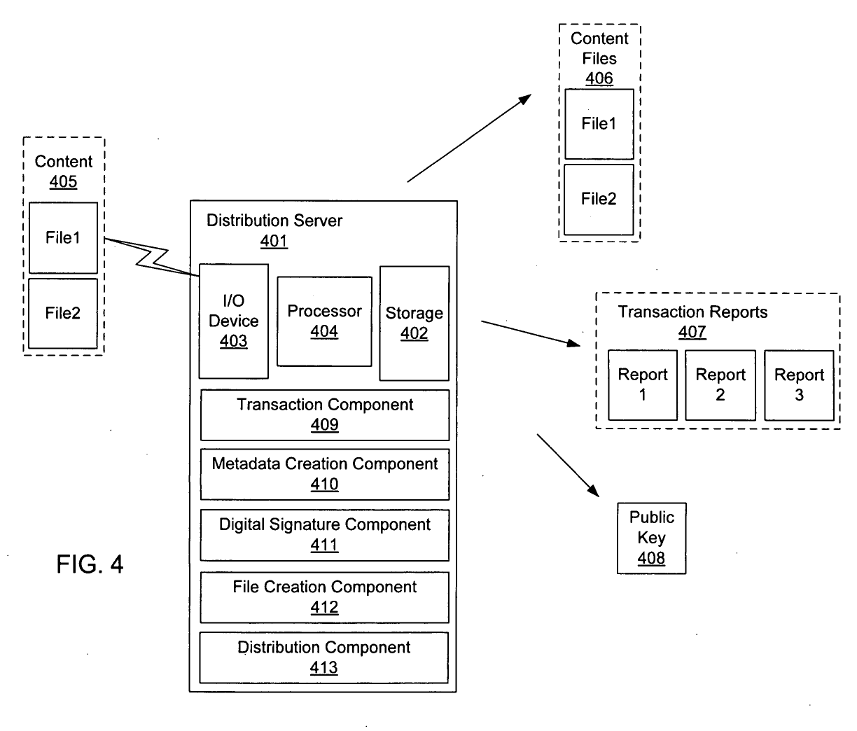

Other example embodiments of the present invention provide for systems to create and distribute digital content files. For example, FIG. 4 illustrates a distribution server 401. Such a server 401 may include a storage device 402, e.g., optical or magnetic media, or flash memory, etc., which may be configured to store content 405 used to create digital files 406. The server 401 may also include one or more I/O devices 403 which may be configured to receive content 405, for example from a content owner, which may then be stored and used to create digital files 406 for distribution. In addition, the server may also include a processor 404, which may be configured to create digital files 406, including metadata and digital signatures.

For instance, example servers 401 may receive requests for digital content files 406, for example received from users of a retailer's system. Servers 401 may be configured to process such requests, and record information associated with users, requests, and transactions for content, etc. For example, example servers 401 may include a transaction component 409, which may be configured to process transactions for content.

Servers 401 may also include a metadata creation component 410, which may be configured to create metadata as described herein, e.g., including a retailer ID, transaction ID, etc. In addition, servers 401 include a digital signature component 411 which may be configured to create a digital signature and signature block based on the metadata, as also explained herein. Servers 401 may also include a file creation component 412 which may then create digital files 406, embedding the metadata and the signature block into a digital file 406 containing the requested content.

Once created, the server 401 may be configured to distribute digital files 406 to users, e.g., using a distribution component 413. As noted above, the server 401 may store information identifying the transaction for the digital file 406. The server 401 may also make that information available to content owners, e.g., in the form of a transaction report 407. Also the server 401 may be configured to generate and manage the keys necessary to create the digital signature and may communicate keys 408 to content owners as required.

### Sales Auditing

Some example embodiments of the present invention provide systems and methods for auditing the sale of digital files. For instance, the owner of digital content may arrange to distribute that content through a number of distributors or retailers. Accordingly, the content owner may provide those distributors with the digital content that is to be distributed, after which the distributors may enter into transactions in which they supply purchasers of the content with digital files encoding the content. Typically, the distributors charge a fee, or collect some other form of payment, for distribution of the content, and are obligated to pay to the content owner royalties based on each transaction. Unscrupulous distributors may, however, not report some or all of the transactions into which they enter, in order to deprive the content owner of such royalties.

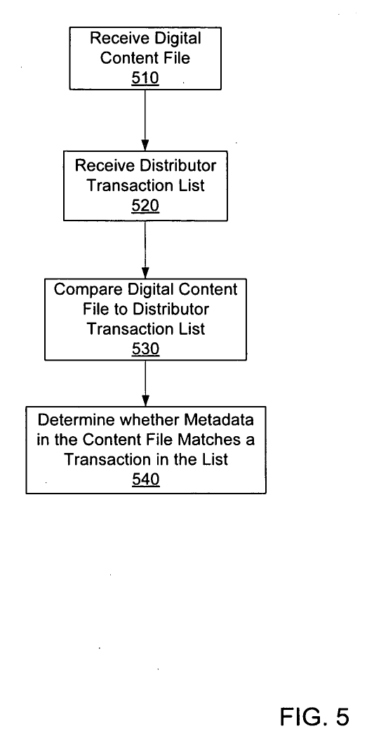

Some example embodiments may, therefore, provide procedures for auditing the sale of digital files, such as the example procedure shown in FIG. 5. An example procedure may begin by receiving a digital file obtained from a content distributor 510. For instance, a selection of digital content may be purchased from a distributor and may be received as digital files of the kind described above containing that content. In some examples, the digital files may be purchased in an anonymous manner. For instance, a content owner may have employees, or others, unknown to the distributor enter into the transactions personally, so that the distributor is unable to determine whether a particular sale is made to a content owner for audit purposes or to an actual user. The content purchased may be any of the content the distributor sells. For instance, a random sampling of content may be purchased.

In addition, the purchase may be made in any manner supported by the distributor. For instance, the purchase may be entered into online using a webpage provided by the content distributor. Similarly the digital files may be received by the purchaser in any supported manner. For example, a digital file containing content may be downloaded immediately, or the digital file may be emailed to a user account, etc.

The content files received may include metadata as described above. For example, as part of its agreement with the content owner, the content distributor may be required to create digital files containing the types of metadata discussed above. Accordingly, the files received from the distributor, if they are legitimate, may have any of the features described herein, including information which uniquely identifies both the distributor itself as well as the transaction in which the digital file was sold.

In some examples, a list of transactions for digital content entered into by the content distributor may also be received 520. For instance, a content owner may require content distributors to periodically, or continuously, report all sales of content. Such a requirement may be part of an agreement according to which the content distributor is permitted to the distribute content owned by the content owner. Reporting may be in any reasonable form. For instance, a list of transactions may be transmitted to the content owner in a predetermined file format.

The listing reported to the content owner may be required to provide sufficient information to uniquely identify each transaction listed. For example, the content distributor may be required to include any of the information which is included in the metadata of the digital files, e.g., a time and date of the transaction, a user ID, a transaction ID, etc. Of course the content distributor may be required to provide additional information in the list of transactions as well.

The digital files purchased from the content distributor may then be compared with the listing of transactions 530. For instance, metadata identifying the transaction in which the digital file was obtained may be extracted from the digital file. That information may then be compared to information contained in the reported list of transactions for the time period in question.

Should the metadata in each of the digital files match transactions found in the list of transactions 540, an indication may be recorded reflecting that each transaction was reported. In such an instance, a content owner may have some comfort that the content distributor is reporting all of its sales in the agreed upon manner. If, however, transaction information in the metadata of one of the content files cannot be found in the transaction list, an indication that the transaction cannot be found may be recorded instead. In such a case, the content owner may be alerted to the fact that it is not receiving reports for each file sold by the content distributor and may act on that information.

It is noted that a content distributor might issue digital files containing duplicate transaction information in an attempt to defeat the audit process discussed above. For instance, if a content distributor were to separately sell two digital files, each identifying the same transaction, it could report only one transaction to the content owner, secure in the knowledge that if either content file was sold to the content owner, the file sold would match a reported transaction. Therefore, the digital files received may be compared to each other. Specifically, the metadata of each digital file may be compared to the metadata of every other digital file received. Should any of the files contain non-unique metadata, that fact may again be recorded and action taken.

Some embodiments may provide a system for auditing sellers of “used” files. For illustration, assume that consumers can sell a previously purchased music track to a retailer that deals in “used” digital downloads, but the retailers may only legally sell each instance of a “used” track once. Similar to the example procedures described for sales auditing above, the content owner may periodically make a series of purchases from a “used” retailer and analyze the metadata for signs of illegal sales. For example, if a content owner buys multiple instances of a single track from a “used” retailer, but each instance is found to contain the same metadata, then the content owner knows that the retailer is selling multiple copies of a single track instance, instead of selling it only once as permitted.

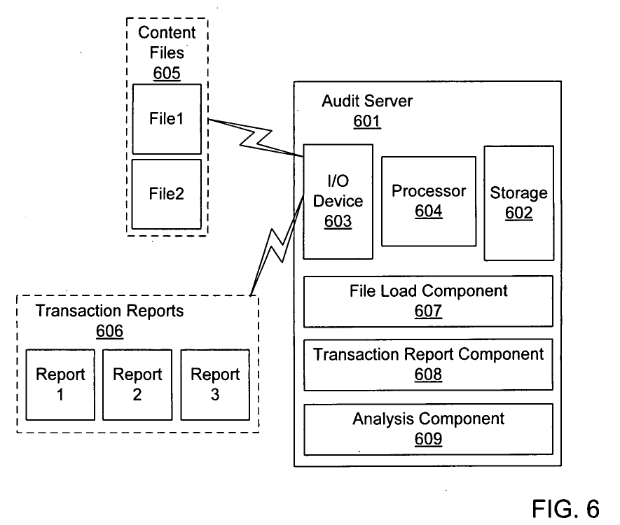

Other example embodiments may provide a system for auditing content distributors. For example, FIG. 6 illustrates an audit server 601 in accordance with an example embodiment of the present invention. Such a server 601 may contain a storage device 602, e.g., magnetic or optical media, or flash memory. In addition, the server 601 may include an I/O device 603 capable of receiving digital files 605. In addition, the server 601 may also include a processor 604, which may be configured to process the digital files 605 received. The server 601 may contain a file load component 607 which may be configured to load digital content files 606 into the server 601. For instance, the server 605 may provide a user interface, using which operators may load digital files 605 purchased from a content distributor. Alternatively, the server 601 may be configured to communicate directly with a content distributor to obtain digital files 605. Once obtained such files 605 may be stored along with information identifying the distributor from whom the files 605 were obtained, the date and time of the transaction, etc.

The server 601 may also include a transaction report component 608 which may be configured to receive transaction reports 606 from content distributors. For example, the server 601 may be in direct communication with content distributors which may notify the server of a transaction as it occurs, may send a periodic report 606 to the audit server, or the server 601 may include a user interface allowing an operator to load a report 606. The audit server 601 may be further configured to save each transaction report 606 according to the content distributor which provided the report 606, etc.

The audit server 601 may also include an analysis component 609 configured to process the digital files 605 received against the transaction reports 606. For example, the server 601 may be configured to process each digital file 605 received from a particular distributor against the report 606 received from that distributor, for example, as described above. The server 601 may be configured to maintain a results database containing the results of the audit for each file 605 processed. In some examples, the audit server 601 may be configured to generate an alert when a digital file 605 fails the audit. In addition, some example servers 601 may be configured to provide audit reports, for example showing audit results for selected distributors.

### Enhanced Feature/Bonus Content Key

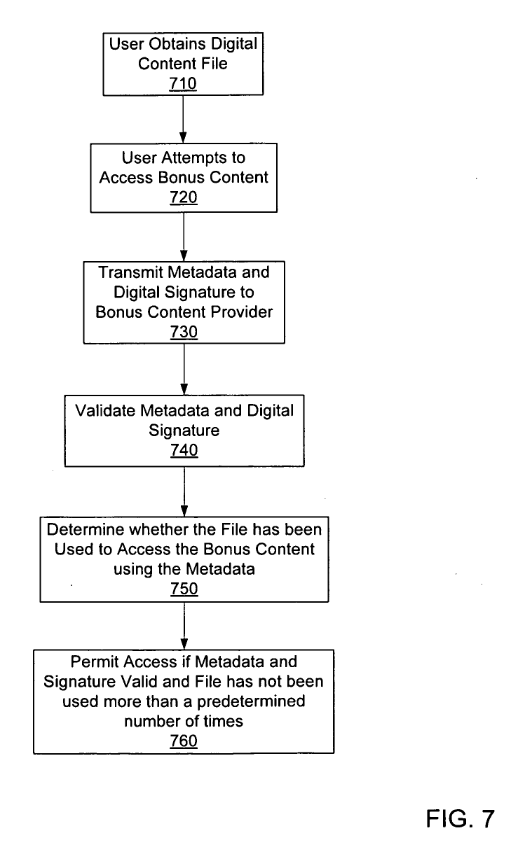

In other embodiments the digital files described above may be used as keys enabling the purchasers of content to access additional bonus material, services, or content. For instance, FIG. 7 illustrates an example procedure for providing additional material to the purchasers of content. For example, a user may purchase and receive a digital file 710. The digital file may contain the types of information described above, including metadata and signature block, etc.

The user may then attempt to access an additional feature 720. The additional feature may take any form and be provided in any acceptable fashion. For example, the addition feature may be additional content provided over the Internet. For instance, if the digital file contains a musical work performed by a particular artist, the additional feature may be an interview with the artist, or an additional track of music, such as a live version of the purchased track. However, the additional content may be any additional content at all, e.g., entry in a prize drawing, access to a service, access to a game, etc.

In order to access the additional content the user may be required to transmit the information stored in the digital file to the service providing the content. For instance, the user may transmit the entire digital file to an authentication server, or may transmit the metadata and signature block to the authentication server 730. In some examples the user may be provided with a client which may extract portions of the digital file for authentication, or may perform the authentication itself.

The metadata and digital signature may then be validated 740. For example, the metadata may be checked to determine whether it has been tampered with, since its creation. As explained above, the metadata may be digitally signed at the time it is created. Because a digital signature of the metadata may only be created by the party that distributed the digital file (as only that party possesses the necessary key), and because the signature itself is based on the metadata, examination of the metadata and the digital signature may demonstrate whether the metadata has been altered. For instance, the metadata and the digital signature may be extracted from a digital file. The digital signature may then be validated using a companion key to the key used to make the signature (if the signature is legitimate). The resulting data may be compared to the metadata itself in some way. For instance, the resulting data may be a hash of the metadata using the hash function specified in the signature block. In such a case, the metadata received may be hashed and the values compared. If the metadata is the same as the metadata upon which the digital signature was based, the metadata of the digital file was likely not altered.

In some examples the metadata identifying the transaction in which the digital file was obtained may be compared to a list of valid transactions, as described above. It is noted that additional content may be offered as to the files distributed from one distributor, or across all distributors, etc. Accordingly, transaction information made available by any number of content distributors may be used to authenticate requests for additional content.

Of course, unscrupulous users may simply make entire copies of the digital files. In order to prevent such copying, access to the additional content may be permitted only a predetermined number of times per digital file. For instance, the provider of additional content may permit access to the additional content only once per digital file purchased. Therefore, on receiving an otherwise valid request for additional content, it may be determined whether the digital file has been used to access the content less than the maximum number of times 750.

Such a determination may be made in any reasonable way. For instance, digital files may contain metadata which may uniquely identify that instance of the digital file. For instance, metadata which contains the elements described herein may be uniquely identified by various metadata elements or combinations of elements. For instance, no two distinct content files will contain the same retailer ID and transaction ID. Because only the retailer in possession of the signature key can generate a valid metadata payload, and because the identifiers included in the metadata may uniquely identify individual instances of digital content files, it may be determined whether a particular digital file has been previously presented to access the bonus content. If the metadata and signature of a digital file are valid, and if metadata which uniquely identifies the digital file instance has not been presented before, the instance of the content file has not been used before. In such a case, a record of the file may be made and future attempts to access the bonus content using the same digital file may be identified.

In other examples, a list of valid transactions may be received from retailers or distributors and each transaction may be associated with an access number. Whenever the additional content is accessed with a digital file whose metadata identifies a transaction, the associated access number may be incremented. Should that number exceed the maximum allowable number on an access attempt, access may be disallowed. Of course any reasonable procedure for tracking access may be employed.

Assuming that the digital file legitimately allows access to the additional content, the user may be provided with access 760. As noted above access may take any reasonable form appropriate to the additional content being provided. For instance, the content may be provided in the form of access to an Internet site, or may allow a user to download a file, or may enter the user in a prize drawing, etc. Of course once access is provided an indication that the additional content has been accessed using the digital file may be recorded and may possibly be used to determine whether future access is permissible.

Note that in example embodiments, the digital file may only be used for initial access to bonus content, while continue access may be provided in other ways. For instance, on accessing the content, a user may be provided the opportunity to create an account on a system. In other examples, the user may be recognized and permitted access based on IP address, device ID, or other identifying characteristic, etc. In some examples, providing access to the user may include issuing an access token to the user, which may then be used to access the content.

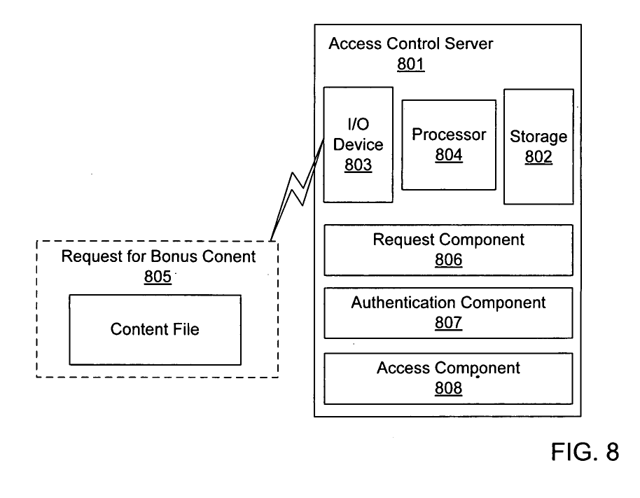

Other embodiments of the invention may provide a system for permitting access to additional content. For instance, as illustrated in FIG. 8, example embodiments may provide an access control server 801, which may be configured to process requests for additional content 805. For example, the access control server may include one or more I/O devices 803, which may, e.g., allow the access control server 801 to connect to a network over which requests to access content 805 may be received. The access control server 801 may also include a storage device 802, e.g., optical or magnetic media, flash or other non-volatile memory, etc. On receiving a request for content 805 the access control server 801 may be configured to store the request in the storage 802. In addition, the server 801 may include a processor, which may be configured to process digital content files and requests for access.

The access control server 801 may include a request component 806 which may be configured to receive requests 805 in any reasonable form. For instance, the access control 801 server may be configured to receive requests 805 directly from users. For instance, the server 801 may provide a user interface, using which users may access the additional content. In order to do so the users may be prompted to upload a digital file to the access control server. Alternatively, the access control server 801 may not receive requests directly from users. For instance, access to the content may be provided by other systems, which may require users to provide the necessary information. Once the information is obtained by those systems, the digital files or portions of files which accompany the requests may be transmitted to the access control server for authentication.

The access control server 801 may also be configured to receive lists of valid transactions. For example, the access control server may be in communication with content distributor systems. The server 801 may receive information identifying each transaction that a content distributor enters into, and may store that transaction information. Again, such information may be received on a continuous or periodic basis and in any form suitable for such communications.

The access control server 801 may also contain authentication component 807 configured to authenticate access requests 805. For instance, upon receiving a request 805, the server 801 may be configured to authenticate the digital file used as the basis of that request. For example, as described above, the server 801 may be configured to extract the metadata from the digital file and may validate the signature and metadata and verify that the particular combination of identifiers appearing in the metadata has not been used more than a maximum permissible number of times; or may compare that metadata to transaction information received from content distributors.

Should a request 805 appear to be legitimate, the access control server 801 may include an access component 808 configured to provide access to content. As above, however, the server 801 may also be configured to store a database of access attempts associated with particular digital files. For instance, the server 801 may store a list of content files which have previously been used to access the content, e.g., identified by the metadata accompanying the content file. Alternatively, the server 801 may store a list associating each valid transaction with a number of times the additional content was accessed based on that transaction. The server 801 may also store an indication of a maximum number of times a digital file may be used to access additional content. For instance, the server 801 may store an indication that each digital file may be used to access additional content one time. As explained above, when processing an otherwise valid request, the server 801 may be configured to determine whether the digital file used to make the request has already reached the maximum number of access attempts.

Should the access control server 801 receive a valid request 805 for access to additional content, the server 801 may be configured to allow the request 805. For instance, the server 801 may itself allow access to addition content. Alternatively, the server 801 may transmit an indication to another system, indicating that the system should allow access to additional content, or may issue an access token to the user which may be used to access the content. In so doing, example servers 801 may also be configured to record and store information relating to the request 805. For example, the server 801 may record information from the digital file itself, information entered by the user in making the request 805, other environmental information, such as the IP address from which the request 805 was made, etc.

### Secure Metadata Carrier

Other embodiments of the present invention may generally allow for the secure transmission of metadata to systems which may rely on the metadata. For example, the metadata in a digital file may indicate a parental advisory flag, e.g., “explicit,” or “clean,” etc. An end user device may be configured with an option which may allow playback of only “edited” content. Accordingly, the device may be configured to check the metadata of each digital file it plays in order to determine whether the content is marked as “clean.” However, it would be generally possible to modify the metadata of a file to circumvent such systems. By providing metadata in the form described above, however, it may be more difficult to alter metadata relied on by end user and other systems processing the digital file.

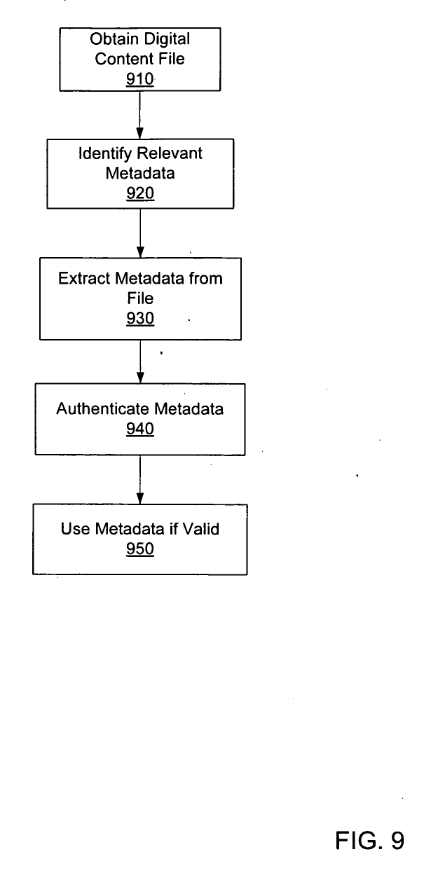

For example, FIG. 9 illustrates an example procedure for using secured metadata stored in a digital file. A digital file containing metadata may first be obtained 910. For example, the digital file may be purchased from a content distributor. As obtained, the digital file may include metadata and other information as explained above.

The digital file may then be searched for metadata of interest 920. In addition to the types of metadata described above, the digital file may contain metadata of numerous kinds, some of which may be useful to a particular application. As examples, the metadata in a content file may contain, parental advisory flags, URLs related to the content (possibly indicating a location from which additional bonus content may be obtained as described above), copyright information, etc.

On identifying a useful piece of metadata, the metadata may be extracted from the digital file 930. Before relying on the metadata 950, however, the metadata may be authenticated 940. For example, assuming the metadata is signed by a digital signature, the digital signature may be processed to determine whether the metadata has been altered, as explained above. In addition, some embodiments may also verify whether the content has been altered, in order to ensure that different content has not been inserted into a digital file. To do so, the secure hash of the content, which may be included in the metadata, may be compared to the content itself, i.e., the content may be hashed using the same algorithm and the values compared. As the secure hash may itself be part of the metadata which is digitally signed, it may be determined whether the hash itself has been modified.

Other example embodiments may provide systems which may utilize the secure metadata included in digital files described above. For example, end user systems and devices such as portable music players, home and automobile audio systems, computer systems, etc. may be provided for which may be capable of relying on such metadata.

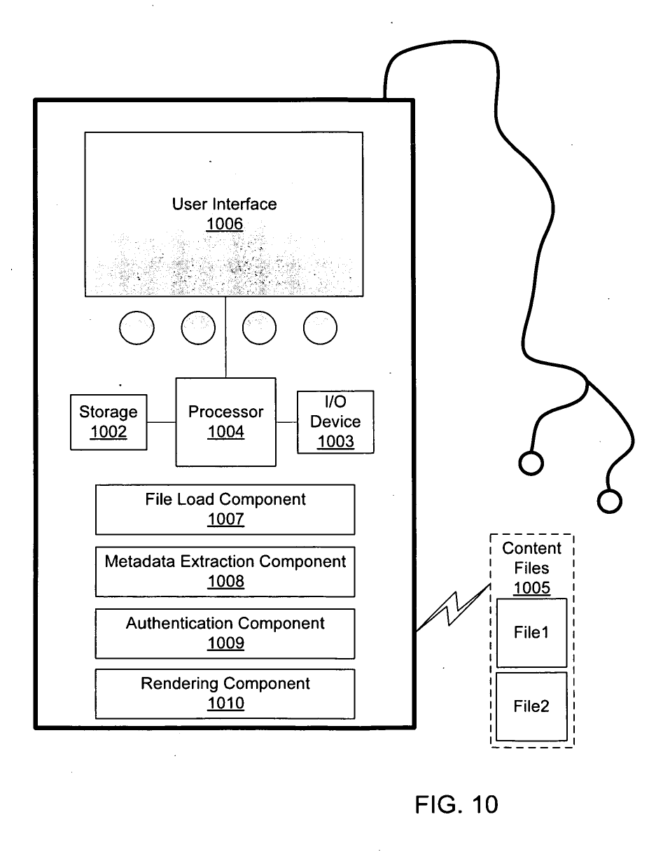

For instance, FIG. 10 illustrates an example system 1001 which may make use of metadata contained in digital files 1005. As illustrated, such an example system 1001 may include a storage 1002 configured to store digital files 1005, which may be loaded into the system using, e.g., a file load component 1007. For example, the storage 1002 may be a flash memory, magnetic or optical media etc. In addition, the system 1001 may include one or more I/O devices 1003 which may be configured to receive digital files 1005, which may then be stored on the storage 1002. The system 1001 may also include a processor 1004 configured to validate and use the metadata.

Example systems 1001 may also include a user interface 1006 which may be used to access the digital files 1005. For example, such a system 1001 may be integrated into a digital music player which may include a screen, inputs such as volume controls, etc. Such a system 1001 may include additional controls through which to access and use metadata or may use the standard controls provided. Such example systems 1001 may be configured to utilize metadata stored in digital files 1005. For example, the example system 1001 may be configured to connect to a service identified by a URL contained in the file 1005. Alternatively, example systems 1001 may make playback decisions based on metadata, e.g., playing back only “edited” files as indicated by the metadata. Accordingly, example systems 1001 may include a rendering component 1010 which may be configured to render content according to authenticated metadata.

Example systems 1001 may also include a metadata extraction component 1008 which ma be configured to analyze the metadata contained in the digital files 1005. For example, such a system 1001 may be configured to search digital files 1005 for metadata and authenticate that metadata as explained above. Such systems may also include an authentication component 1009 which may be configured to validate the metadata found in digital content files 1005, for example using a digital signature as described herein. Systems 1001 may be configured to disregard metadata, and possibly refuse to access the digital file 1005 at all, if it is determined that the metadata is not authentic.

It will be appreciated that all of the disclosed methods and procedures described herein may be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It will further be appreciated that the above-described methods and procedures may be provided using the systems disclosed herein, or on other types of systems. The methods and procedures, unless expressly limited, are not intended to be read to require particular actors or systems performing particular elements of the claimed methods.

It will also be appreciated that the system components discussed herein may be provided as hardware, firmware, software or any combination thereof. If provided as software, such software may be stored in memory, for example in RAM, ROM, flash or other non-volatile memory, etc., or may be stored on another machine readable medium, such as magnetic or optical media, etc. In addition such software may be preloaded, or may be acquired and stored during functioning of a system.

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense. It is also noted that the subject matter headings used throughout the specification are intended only as an organizational aid and are not to be read as limiting the scope of the disclosure.

1-22. (canceled)

23. A method of auditing a distributor of digital content, comprising:
receiving, with a digital content audit server, a content file obtained from a content distributor through a transaction, the content file containing metadata uniquely identifying the transaction and a digital signature of at least a portion of the metadata;
receiving, with the digital content audit server, from the content distributor a list of transactions for content files entered into by the content distributor;
searching, with the digital content audit server, the list of transactions for the transaction identified by the metadata; and
responsive to an indication that the transaction was not found, recording, with the digital content audit server, an indication that the transaction was not reported.

24. The method of claim 23, further comprising:
receiving, with the digital content audit server, a second content file obtained from the content distributor through a second transaction, the second content file containing second metadata uniquely identifying the second transaction and a second digital signature of at least a portion of the second metadata;
comparing, with the digital content audit server, the metadata to the second metadata; and
responsive to a determination that a portion of the metadata uniquely identifying the transaction is identical to a portion of the second metadata uniquely identifying the second transaction, recording, with the digital content audit server, an indication that the content distributor is not property identifying transactions.

25. The method of claim 23, wherein the metadata includes:
a distributor identifier;
a date and time of the transaction;
an asset identifier;
a secure hash generated from a non-metadata portion of the content file;
a nonce, randomly generated at the time of the transaction; and
one of a user identifier, uniquely identifying the user, and a transaction identifier, uniquely identifying the transaction.

26. The method of claim 23, wherein:
the content file is an MP3 file; and
the metadata and the digital signature are embedded in a PRIV ID3 tag.

27. The method of claim 23, wherein the metadata and the digital signature are in XML form.

28. A digital content audit server, comprising:
a file load component configured to receive a content file obtained from a content distributor through a transaction, the content file containing metadata uniquely identifying the transaction and a digital signature of at least a portion of the metadata;
a transaction report component configured to receive from the content distributor a list of transactions for content files entered into by the content distributor; and
a analysis component configured to search the list of transactions for the transaction identified by the metadata, and, responsive to an indication that the transaction was not found, record an indication that the audit failed.

29. The server of claim 28, wherein:
the file load component is further configured to receive a second content file obtained from the content distributor through a second transaction, the second content file containing second metadata uniquely identifying the second transaction and a second digital signature of at least a portion of the second metadata; and
the analysis component is further configured to compare the metadata to the second metadata, and, responsive to a determination that a portion of the metadata uniquely identifying the transaction is identical to a portion of the second metadata uniquely identifying the second transaction, record an indication that the content distributor is not property identifying transactions.

30. The server of claim 28, wherein the metadata includes:
a distributor identifier;
a date and time of the transaction;
an asset identifier;
a secure hash generated from a non-metadata portion of the content file;
a nonce, randomly generated at the time of the transaction; and
one of a user identifier, uniquely identifying the user, and a transaction identifier, uniquely identifying the transaction.

31. The server of claim 28, wherein:
the content file is an MP3 file; and
the metadata and the digital signature are embedded in a PRIV ID3 tag.

32. The server of claim 28, wherein the metadata and the digital signature are in XML form.

33. A method of providing access to bonus content, comprising:
receiving, with an access control server, metadata and a digital signature which are associated with a content file obtained from a content distributor through a transaction, wherein the metadata uniquely identifies the transaction, and wherein the digital signature is made from at least a portion of the metadata;
validating, with the access control server, the metadata and the digital signature;
determining, with the access control server, whether access to bonus content has been requested more than a predetermined number of times using the content file, where the content file is identified using the metadata; and
responsive to an indication that the digital signature and the metadata are valid and an indication that access to the bonus content has been requested less than the predetermined number of times using the content file, allowing access to the bonus content, with the access control server.

34. The method of claim 33, wherein the metadata includes:
a distributor identifier;
a date and time of the transaction;
a track identifier;
a secure hash generated from a non-metadata portion of the content file;
a nonce, randomly generated at the time of the transaction; and
one of a user identifier, uniquely identifying the user, and a transaction identifier, uniquely identifying the transaction.

35. The method of claim 33, wherein:
the content file is an MP3 file; and
the metadata and the digital signature are embedded in a PRIV ID3 tag.

36. The method of claim 33, wherein the metadata and the digital signature are in XML form.

37. The method of claim 33, wherein the predetermined number is 1.

38. The method of claim 33, wherein determining whether access to the bonus content has been requested more than a predetermined number of times using the content file, comprises searching for the metadata in a list of metadata used to request access to the bonus content.

39. The method of claim 33, wherein the metadata and the digital signature are embedded in the content file.

40. The method of claim 33, wherein allowing access to the bonus content further comprises issuing an access token configured to allow access to the bonus content.

41. An access control server for providing access to bonus content, comprising:
a request component configured to receive metadata and a digital signature which are associated with a content file obtained from a content distributor through a transaction, wherein the metadata uniquely identifies the transaction, and wherein the digital signature is made from at least a portion of the metadata;
a validation component configured to validate the metadata and the digital signature, and configured to determine whether access to bonus content has been requested more than a predetermined number of times using the content file, where the content file is identified using the metadata; and
an access component configured to, responsive to an indication that digital signature and the metadata are valid and an indication that access to the bonus content has been requested less than the predetermined number of times using the content file, allow access to the bonus content.

42. The server of claim 41, wherein the metadata includes:
a distributor identifier;
a date and time of the transaction;
an asset identifier;
a secure hash generated from a non-metadata portion of the content file;
a nonce, randomly generated at the time of the transaction; and
one of a user identifier, uniquely identifying the user, and a transaction identifier, uniquely identifying the transaction.

43. The server of claim 41, wherein:
the content file is an MP3 file; and
the metadata and the digital signature are embedded in a PRIV ID3 tag.

44. The server of claim 41, wherein the metadata and the digital signature are in XML form.

45. The system of claim 41, wherein the predetermined number is 1.

46. The server of claim 41, wherein the validation component is further configured to determine whether access to the bonus content has been requested more than a predetermined number of times using the content file by searching for the metadata in a list of metadata used to request access to the bonus content.

47. The server of claim 41, wherein the metadata and the digital signature are embedded in the content file.

48. The server of claim 41, wherein the access component is further configured allow access to the bonus content by issuing an access token configured to allow access to the bonus content.

49. A method of rendering media content based on authenticated metadata, comprising:
receiving, with a rendering device, a content file containing metadata and a digital signature of at least a portion of the metadata, wherein the metadata includes a secure hash of media content stored in the content file;
identifying, with the rendering device, information in the metadata usable to control rendering of the media content;
determining, with the rendering device, whether the metadata is the same as original metadata used to create the digital signature;
determining, with the rendering device, whether the media content is the same as original media content used to create the secure hash; and
responsive to an indication that the metadata is the same as the original metadata and the media content is the same as the original media content, rendering, with the rendering device, the media content according to the information.

50. The method of claim 49, wherein the metadata includes:
a distributor identifier;
a date and time of the transaction;
an asset identifier;
a nonce, randomly generated at the time of the transaction; and
one of a user identifier, uniquely identifying the user, and a transaction identifier, uniquely identifying the transaction.

51. The method of claim 49, wherein:
the content file is an MP3 file; and
the metadata and the digital signature are embedded in a PRIV ID3 tag.

52. The method of claim 49, wherein the metadata and the digital signature are in XML form.

53. A media rendering system, comprising:
a file load component configured to receive a content file containing metadata and a digital signature of at least a portion of the metadata, wherein the metadata includes a secure hash of media content stored in the content file;
a metadata extraction component configured to identify information in the metadata usable to control rendering of the media content;
an authentication component configured to determine whether the metadata is the same as original metadata used to create the digital signature, and configured to determine whether the media content is the same as original media content used to create the secure hash; and
a rendering component configured to, responsive to an indication that the metadata is the same as the original metadata and the media content is the same as the original media content, render with the rendering device, the media content according to the information.

54. The system of claim 53, wherein the metadata includes:
a distributor identifier;
a date and time of the transaction;
an asset identifier;
a nonce, randomly generated at the time of the transaction; and
one of a user identifier, uniquely identifying the user, and a transaction identifier, uniquely identifying the transaction.

55. The server of claim 53, wherein:
the content file is an MP3 file; and
the metadata and the digital signature are embedded in a PRIV ID3 tag.

56. The server of claim 53, wherein the metadata and the digital signature are in XML form.

57-58. (canceled)
